(19) United States
(12) Patent Application Publication
(10) Pub. No.: US 2026/0125856 A1
(43) Pub. Date: May 7, 2026

(54) MACHINE TO RETRIEVE AND INSTALL A RAIL ANCHOR

(71) Applicant: Transportation IP Holdings, LLC, Norwalk, CT (US)

(72) Inventor: Ryan Matthew Holschbach, Mukwonago, WI (US)

(73) Assignee: Transportation IP Holdings, LLC, Norwalk, CT (US)

(21) Appl. No.: 18/936,252

(22) Filed: Nov. 4, 2024

(51) Int. Cl. E01B 29/32; B23P 19/04

(52) U.S. Cl. CPC E01B 29/32; B23P 19/04

(57) ABSTRACT

A machine for applying rail anchors is disclosed. The machine includes a frame, a workhead pivotably mounted to the frame, a pivot arm pivotably mounted to the workhead, an anchor delivery chute mounted to the frame and dimensioned to hold an anchor, an actuator actuatable to release the anchor from the anchor delivery chute, a jaw pivotable by the pivot arm toward the anchor delivery chute, and a clamp to releasably clamp the anchor to the jaw to retrieve the anchor from the anchor delivery chute.

### BACKGROUND

### Technical Field

This disclosure relates to railroad right-of-way maintenance machinery.

### Discussion Of Art

During the course of railroad maintenance work, anchors are often removed during the replacement of rail ties, tie plates, and/or rails and for other maintenance operations. Once the desired maintenance is complete, anchors are reinstalled. In some instances, new anchors need to be installed. A pivoting anchor applicator clipping mechanism may pivot from a gauge side between the rails to a position beneath the rails towards a field side or outside of the track to install anchors to the track. Rail anchors have different configurations, including spring-type or drive-on anchors, for example. An anchor may have a geometry designed to increase the contact bearing surface area between the anchor and the portion of the track that the anchor is contacting. It may be desirable to have an anchor system and method that differs from those that are currently available.

### BRIEF DESCRIPTION

In one aspect, a machine is provided for applying anchors. The machine includes a frame, a workhead pivotably mounted to the frame, a pivot arm pivotably mounted to the workhead, an anchor delivery chute mounted to the frame and dimensioned to hold an anchor, an actuator actuatable to release the anchor from the anchor delivery chute, a jaw pivotable by the pivot arm toward the anchor delivery chute, and a clamp to releasably clamp the anchor to the jaw to retrieve the anchor from the anchor delivery chute. In one aspect, the anchor delivery chute further comprises a door at an end thereof and the actuator is positioned to pivot the door to release the anchor from the loaded position in the anchor delivery chute.

In one aspect, a machine includes an anchor delivery chute. The chute may include a first sidewall, a second sidewall, and a track positioned between the first sidewall and the second sidewall. An anchor is positionable along the track to slide into a loaded position in the anchor delivery chute under gravitational forces. A release door may be pivotably coupled to the first sidewall. The machine further includes an actuator to pivot the release door relative to the first sidewall to release the anchor from the loaded position.

In one aspect, a machine for applying an anchor to a rail may include a frame movable along a longitudinal rail axis, a workhead pivotably mounted to the frame, the workhead pivotable in a plane transverse to the longitudinal rail axis; the machine further comprises a pivot arm pivotably mounted to the workhead, an anchor delivery chute dimensioned to hold at least one anchor, a jaw pivotable by the pivot arm toward the anchor delivery chute, and a clamp to releasably clamp the head of the anchor to the jaw to retrieve the anchor from the anchor delivery chute.

In one aspect, the jaw of the pivot arm can be structured to accommodate anchors of various geometries. In one aspect, the transfer of the anchor from the anchor delivery chute to the pivotable jaw can ensure anchors of various geometries are compatible with the machine without requiring overly complicated machinery or mechanism therefor.

### BRIEF DESCRIPTION OF THE DRAWINGS

FIG. 1 is a perspective view of an anchor application machine, according to various aspects.

FIG. 1A is a detail view of the anchor application machine of FIG. 1 with various features removed for illustrative purposes, according to various aspects.

FIG. 2 is a perspective view of a jaw and an anchor delivery chute of the anchor application machine of FIG. 1, according to various aspects.

FIG. 3 is a perspective view of the anchor delivery chute of FIG. 2, according to various aspects.

FIG. 4 is a top perspective view of a portion of the anchor delivery chute of FIG. 3, according to various aspects.

FIG. 5 is a side perspective view of a portion of the anchor delivery chute of FIG. 3, according to various aspects.

FIG. 6 is a perspective view of a guide door of the anchor delivery chute of FIG. 3, according to various aspects.

FIG. 7 is a perspective view of a catch door of the anchor delivery chute of FIG. 3, according to various aspects.

FIG. 8 is a perspective view of the jaw of FIG. 2, according to various aspects.

FIG. 9 is an elevation view of the jaw of FIG. 8, according to various aspects.

FIG. 10 is a cross-sectional perspective view of the jaw of FIG. 8 in which internal components are exposed, according to various aspects.

FIGS. 11-15 depict an operational series for applying an anchor with the anchor application machine of FIG. 1, according to various aspects.

### DETAILED DESCRIPTION

This disclosure relates to railroad right-of-way maintenance machinery. Right-of-way machinery may be used for applying anchors to rails for maintaining track alignment. An anchor, or rail anchor, may be clamped onto a rail and positioned to abut the tie and, in some cases, the tie plate, to resist movement of the rail relative to the tie in a direction transverse to the rail.

In one embodiment, a machine for applying anchors includes a frame, a workhead pivotably mounted to the frame, a pivot arm pivotably mounted to the workhead, an anchor delivery chute mounted to the frame and dimensioned to hold an anchor, an actuator actuatable to release the anchor from the anchor delivery chute, a jaw pivotable by the pivot arm toward the anchor delivery chute, and a clamp to releasably clamp the anchor to the jaw to retrieve the anchor from the anchor delivery chute. In some cases, the anchor delivery chute has a door at an end thereof and the actuator is positioned to pivot the door to release the anchor positioned at the end of the anchor delivery chute.

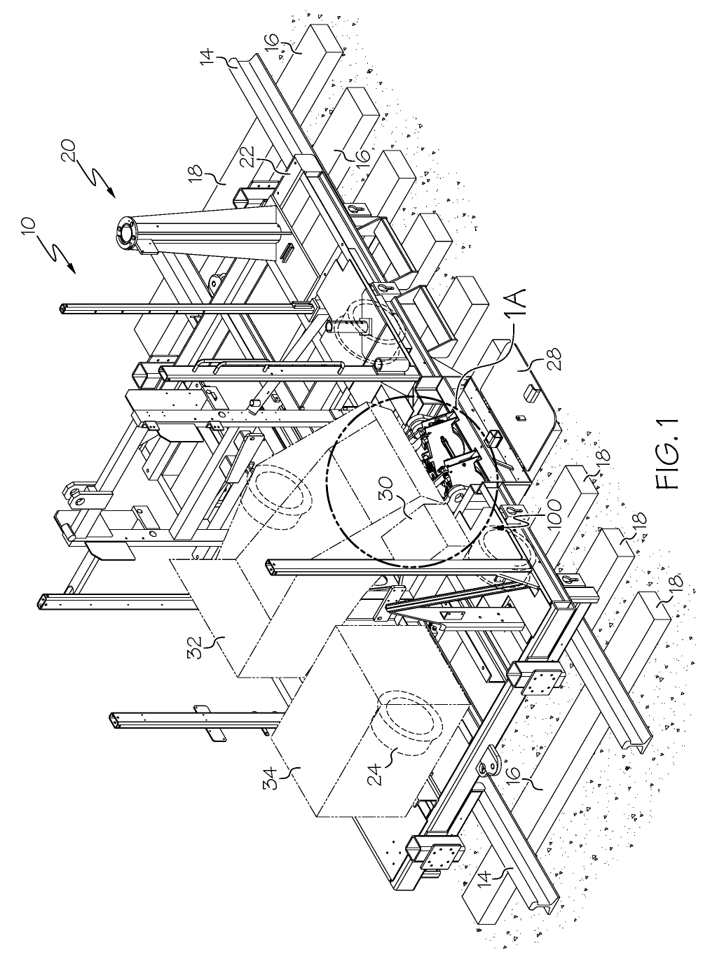

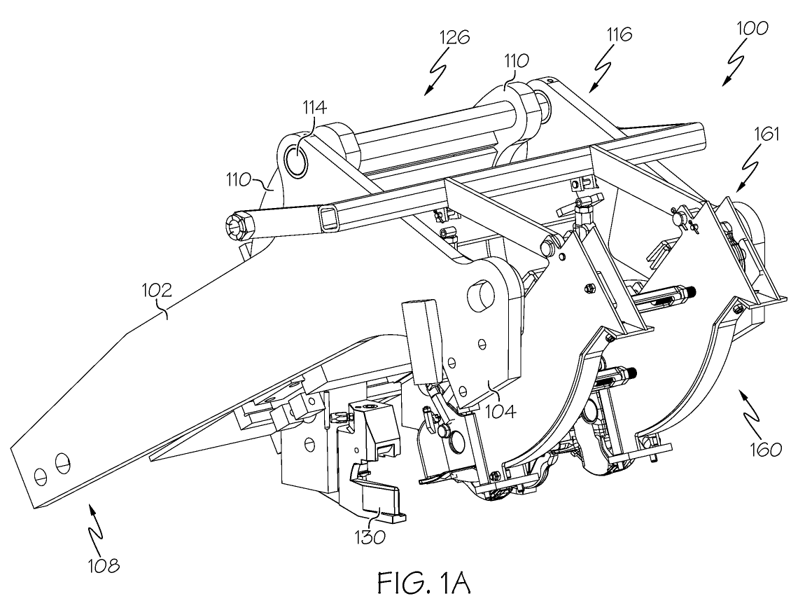

FIGS. 1, 1A, and 11-15 Referring primarily to , a railway maintenance machine 10 includes an anchor applicator 100 for applying anchors 12 onto rails 14 to anchor rail tie plates 16 and ties 18 to the rails. The anchors, the rails, the tie plates, and the ties may be referred to as a track or railroad track and is designated with the refence number 20 herein. In certain instances, the railway maintenance machine may support additional functions. These additional functions may be tools for removing anchors, cribbing, and the like.

The railway maintenance machines and anchor applicators may install anchors as depicted and disclosed herein. Suitable anchors may include the VIPER-1 rail anchor available from Lewis Bolt and Nut Co. Alternative anchor designs may be used with the railway maintenance machines and anchor applicators disclosed herein subject to end use requirements and parameters.

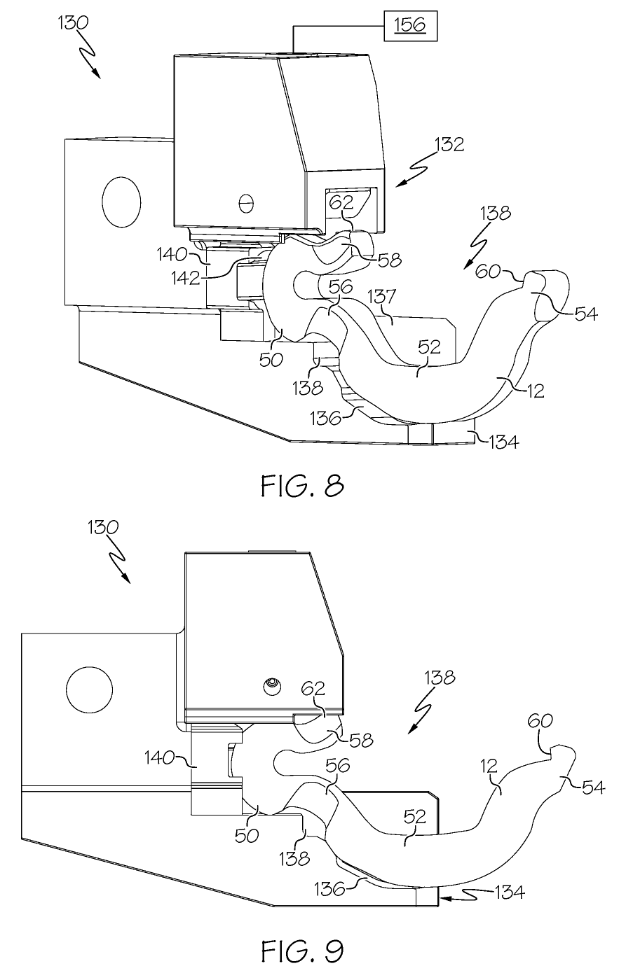

Referring primarily to FIG. 9, each anchor may include a head 50, a tail 52, and a belly 54 extending between the head and the tail. The anchors may define a neck 56 between the head and the belly. The neck is a smaller or tapered cross-section of the anchor as compared with the head and the belly of the anchor. The anchors further include an ear 58 protruding from the head and extending toward the tail, and a notch 60 along the tail facing the ear. The ear is a smaller or tapered cross-section of the anchor than the head of the anchor. The ear terminates at a crest 62.

The belly of the anchor includes side surfaces on opposite sides. Each side surface includes a contact-bearing surface area for contacting the side of a railroad track crosstie. The contact-bearing surface area is adapted to engage with and stabilize lower or deeper portions of a crosstie as compared with other anchors. A suitable anchor may have a relatively higher contact-bearing surface than a typical anchor. As an example, the anchor may have a contact-bearing surface area of about 5.6 square inches, whereas a typical anchor in current use may have a contact-bearing surface area of approximately 2.9 square inches. In this example, the example anchor of this disclosure has a contact-bearing surface area more than 93% larger than the reference anchor. A portion of the increased surface area may be located on the bottom or lower portion of the anchor, such that the contact-bearing surface area can contact and engage with lower or deeper portions of a crosstie. In this embodiment, the anchor may provide increased bearing and support, including as the crosstie deteriorates over time.

In some example implementations, the contact-bearing surface area can be at least 3.0 square inches and can be adapted to extend at least 1.5 inches downward from the top of a railroad track crosstie along a side of the railroad track crosstie. In some implementations, the contact-bearing surface area can be about 5.5 square inches. In some other example implementations, the height of the contact-bearing surface area that hangs below a horizontal plane representing the top of a crosstie and where the anchor contacts the side of the crosstie can be about 2.4 inches. In some other example implementations, a middle portion of the belly section can have a height of about 1.156 inches.

In some other example implementations, a top-to-bottom thickness of a substantial portion of the head can be at least about 0.875 inches, e.g., the resulting thickness of the head after being bent during the manufacturing process. In some other example implementations, the notch formed in the tail can have a height of about 0.15 inches. In some implementations, the portion of the tail that is beyond the notch can have a length of between about 0.4 to 0.8 inches. In some other example implementations, the jaw of the anchor can have an opening of about 0.5 inches, e.g., slightly less than the thickness of the base of a standard rail. The jaw opening may be sized to facilitate or allow the jaw of the anchor to deflect when installed and to produce a clamping force that holds the jaw of the anchor in place on the rail.

In some other example implementations, the distance between the most distant ends of the jaw of the anchor and the notch can be about 6.125 inches, e.g., matching the width of the base of a standard rail. For example, the opening in the jaw of the anchor can be sized to allow for easy and efficient installation of the anchor onto the base of a standard rail.In some implementations, for anchors manufactured for rails of other sizes (e.g., a 5½ inch rail), the distance between the most distant ends of the jaw and the notch can be different (e.g., about 5⅝ inches).

Referring to FIG. 1, the railway maintenance machine may include a frame 22. The frame may be supported on wheels 24 such that the frame is movable along the track, either by being self-propelled by a source of motive power such as an engine 34 or, in other cases, by being towable by another powered vehicle. The railway maintenance machine may include an operator's station 28 for providing a platform and, in some cases, a seat, for an operator of the machine. The operator’s station may include at least one operator input such as a trigger, a switch, a joystick, a button, or any other input mechanism. The input may control the operation of the frame and the maintenance functions of the machine. Control may include actuation of the various actuators. The actuators may be used for loading, transferring, retrieving, and applying anchors to the track. The frame supports a control panel 30 adjacent to the operator’s station, at which the operator provides control inputs to control the railway maintenance machine.

In various instances, a bulk storage compartment 32 may be adjacent to the operator’s station. The compartment may hold anchors. The anchors may be subsequently provided to the anchor applicator. This hand off may be either manually or automatically, and the hand off may be selectively switchable in one embodiment.

The railway maintenance machine may move along a longitudinal track axis of the track. The movement may be in either direction. For purposes of discussion, the forward direction “F” is towards the direction of travel, and the rearward direction “R” is away from the direction of travel; however, it is contemplated that the direction of travel by the railway maintenance machine is reversable along the longitudinal track axis. Also, the gage side “GG” of the railroad track is between the rails, while the field side “FD” is outside of each rail. Upwards “U” is away from the ground and downwards “D” is towards the ground.

The railway maintenance machine may include at least one anchor applicator. Each anchor applicator may be positioned to simultaneously apply a pair of anchors side-by-side along a track to simultaneously apply an anchor on either side of a tie.

In other instances, the railway maintenance machine may include two or more anchor applicators. The multiple anchor applicators may be identical or substantially identical to each other. For example, mirror image units may be incorporated into the machine. In such instances, mirror image anchor applicators of the railway maintenance machine may operate simultaneously and/or alternatingly to install anchors on opposite sides of the track, i.e. along each rail thereof, for example.

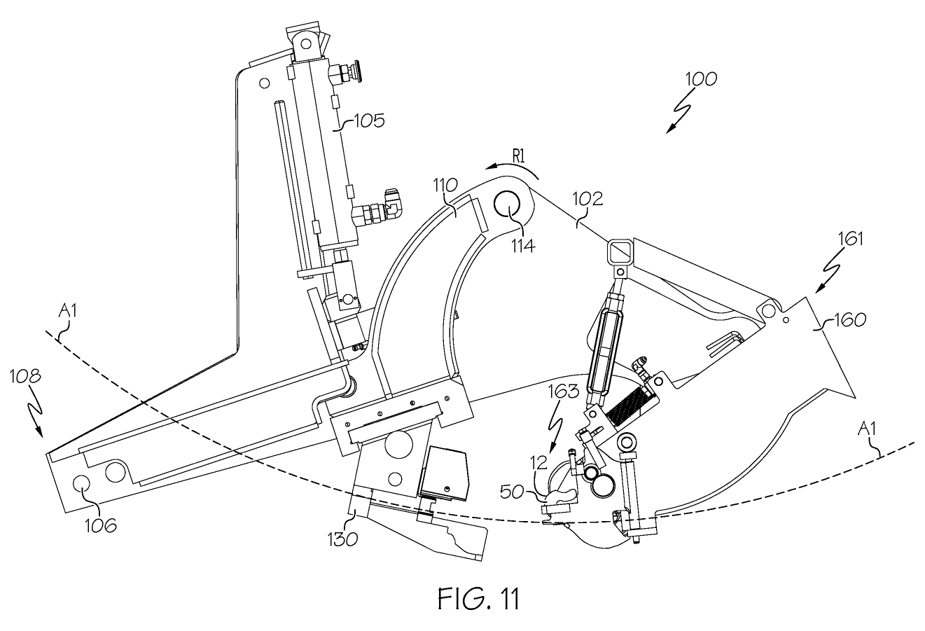

The anchor applicator may include a workhead 102. The workhead may be pivotably mounted to the frame. The workhead is pivotable in a plane transverse to the longitudinal rail axis. For example, referring to the orientation shown in FIGS. 11-15, the longitudinal rail axis is into/out of the page and the workhead pivots about the plane of the page (e.g. CC or CCW in the plane of the page). The workhead may be movable to apply a compressive force to the anchors to clamp the anchors in position along the track.

Referring to FIG. 1A, the anchor applicator may include parallel anchor delivery chutes. The workhead further may include parallel pivot arms where each arm can retrieve an anchor from the respective anchor delivery chute and apply the anchor to the track. More specifically, a pair of anchors are simultaneously applied to a rail on opposing sides of the tie. In other instances, the anchor applicator may include a single pivot arm and a single anchor delivery chute to apply anchors one at a time, for example. In still other instances, the anchor applicator and workhead thereof may support more than two pivot arms to apply more than two anchors simultaneously.

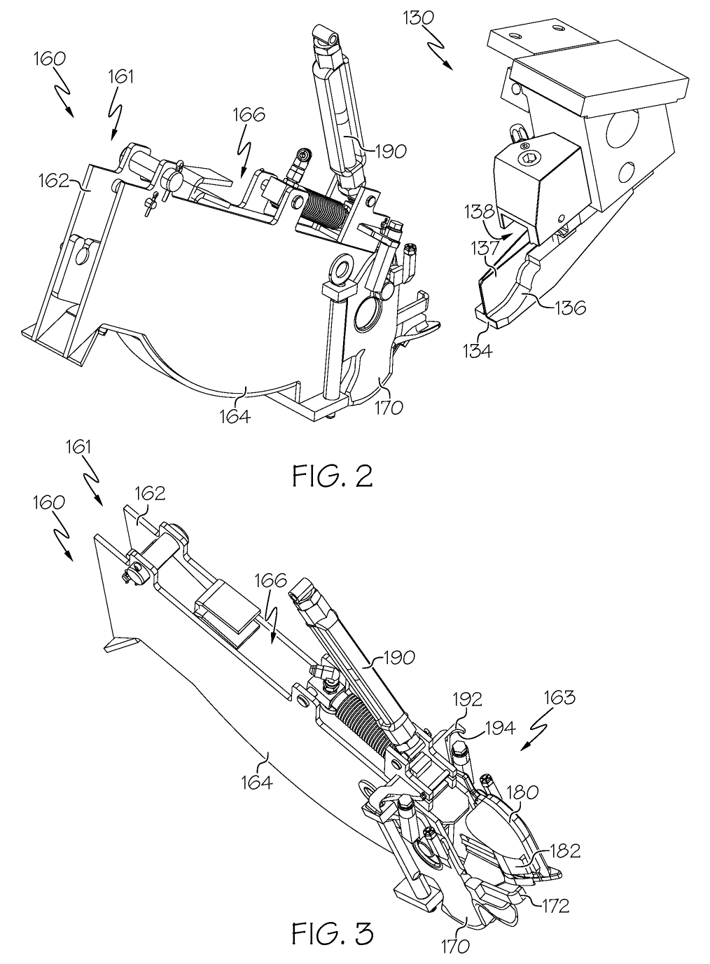

Each pivot arm may be pivotably mounted to the workhead and each may include a jaw 130. The jaw may be referred to as a gripper block. The jaw extends from the respective pivot arm and defines the end of the pivot arm. The pivot arms move the jaws toward and away from the respective anchor delivery chute, which is dimensioned to hold at least one anchor. Referring primarily to FIG. 2, the jaw of the anchor applicator further may include a clamp to releasably clamp the head of the anchor to the jaw. The clamp is structured to grab and grip or hold the anchor to remove and retrieve it from the anchor delivery chute. The transfer of anchors between the anchor delivery chute and the pivot arm facilitates sequential release of the anchors from the anchor delivery chute and appropriate placement of the anchors relative to the track without requiring complex mechanisms for positioning the anchors relative to the track and installing the anchors.

The anchor delivery chute may be mounted to the machine frame. Gravitational forces draw the anchor(s) along the anchor delivery chute toward the loaded position therein. The anchor delivery chute preferably has an inclined orientation, which extends downward D from or adjacent to the operator’s station. While the anchor delivery chute preferably is declined, it is contemplated that any orientation may be used. The anchor delivery chute is fixed relative to the frame.

In other cases, adjustability of the orientation of the anchor delivery chute is contemplated. For example, the placement and/or orientation of the anchor delivery chute may be adjusted to accommodate anchors having a different size and/or shape. In some cases, the anchor delivery chute is a magazine for storing a plurality of anchors and delivering them sequentially to the loaded position for removal by the jaw and clamp thereof.

The anchor delivery chute is dimensioned to guide the anchors into the loaded position at a delivery location (i.e. an end of the anchor delivery chute opposite the entry/input end thereof). While other orientations and configurations are contemplated, the present anchor delivery chute is structured to accommodate the anchors in an arrangement such that the head 50 of the anchor is oriented downward “D” in the direction of the track and the belly 52 of the anchor is facing upwards “U”. The machine maintains the anchor in the belly-up orientation from the time it is loaded into the anchor delivery chute to the time it is installed in the track. Further, the anchor is disposed in a head-to-tail arrangement. In other embodiments, a tail-to-head arrangement may be used.

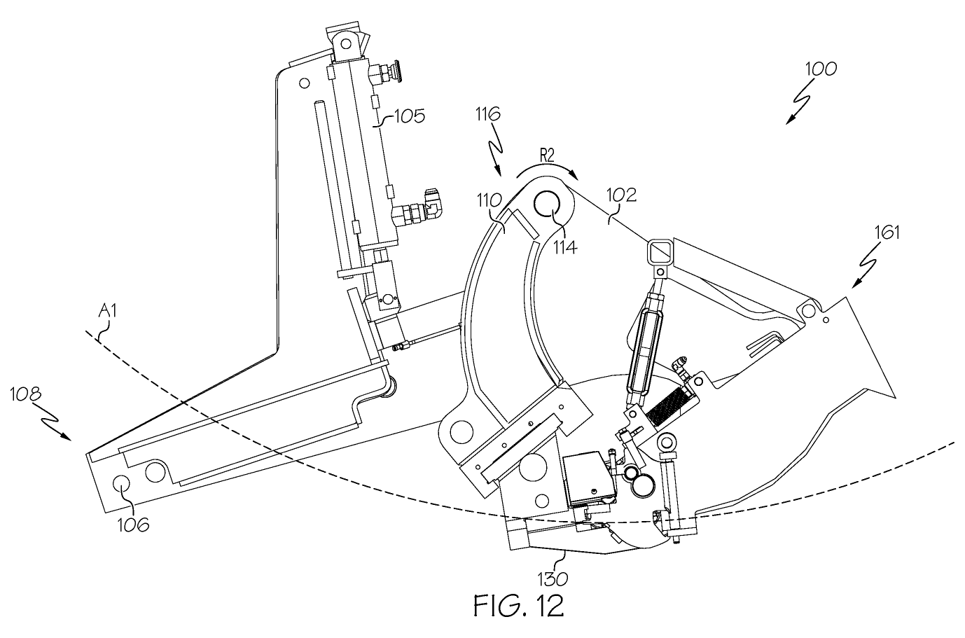

FIGS. 11-15 depict an operational sequence for applying an anchor with the anchor applicator. In a first position (e.g. FIG. 11), the anchor applicator (and workhead thereof) is in a raised position in which the anchor applicator and the workhead are lifted upward “U” away from the track. In the raised position, the pivot arm is pivotable at the arm pivot joint 136 about an arm pivot axis 114 to pivot the jaw at the opposite end of the arm toward and away from the anchor delivery chute. In various cases, the raised position ensures the pivot arm and jaw are positioned to move back and forth along an operational arc A without interference by the track or other components of the railway maintenance machine. The pivot arm is pivotable from the first position (FIG. 11) along a first arc A1 in a first direction, e.g. CCW rotation R1 at arm pivot joint, to a second position (FIG. 12) in which the anchor is transferred between the anchor delivery chute and the jaw.

FIG. 12 depicts a transfer position of the anchor. More specifically, the anchor delivery chute may provide the anchor in a loaded position and the delivery location thereof and the pivot arm and jaw move into engagement with the anchor delivery chute to transfer the anchor from the anchor delivery chute to the jaw. Actuators and clamps may be timed to simultaneously, or nearly simultaneously, facilitate release of the anchor from the anchor delivery chute and securement of the anchor by the jaw.

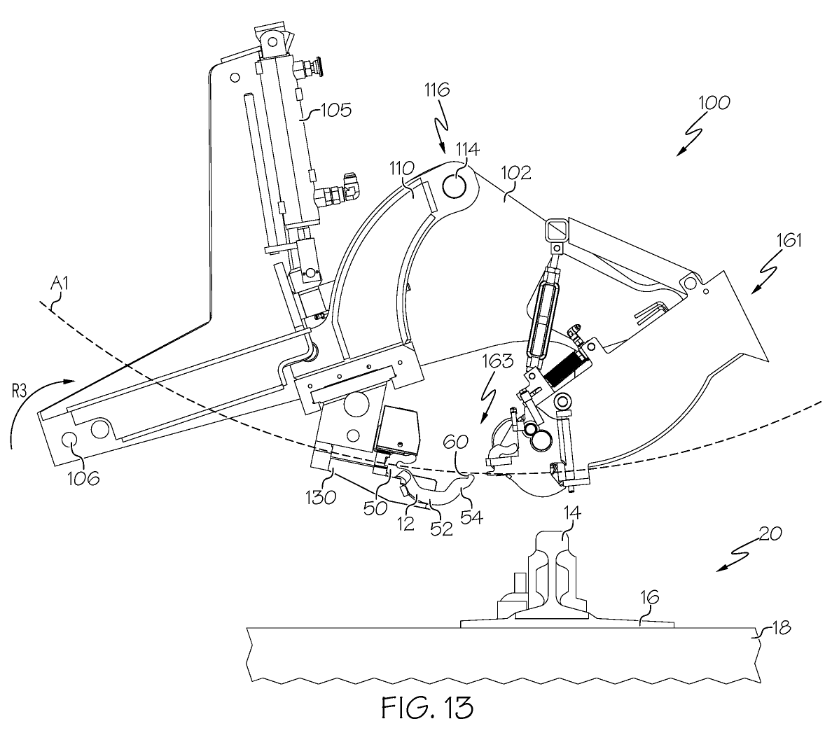

From the second position, the pivot arm holding the transferred anchor clamped therein is pivotable along the first arc in a second direction, e.g. CW rotation R2 at arm pivot joint, from the second position to a third position (FIG. 13), in which the anchor is in a retrieved position. In the retrieved position, the anchor has been loaded and clamped into the retracted jaw. In some cases, the first and third positions of the pivot arm are the same position but, different first and third positions of the pivot arm are contemplated. The pivot arm swings back and forth along the same arc to retrieve the anchor from the anchor delivery chute.

The anchor may be released from the loaded position in the anchor delivery chute for transfer to the jaw by an actuator positioned to engage the anchor delivery chute to release the anchor. The actuator, upon being actuated, may be positioned to engage a door at the end of the anchor delivery chute to open the door and release the anchor into the jaw. Simultaneously, or nearly simultaneously, the jaw may engage the anchor and the clamp thereof is actuated to clamp the anchor to the jaw.

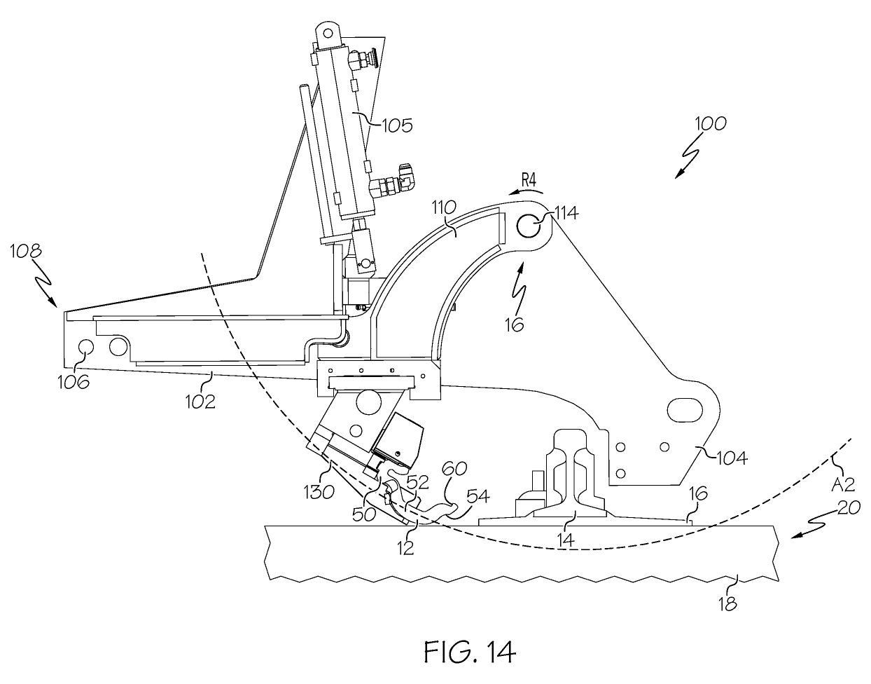

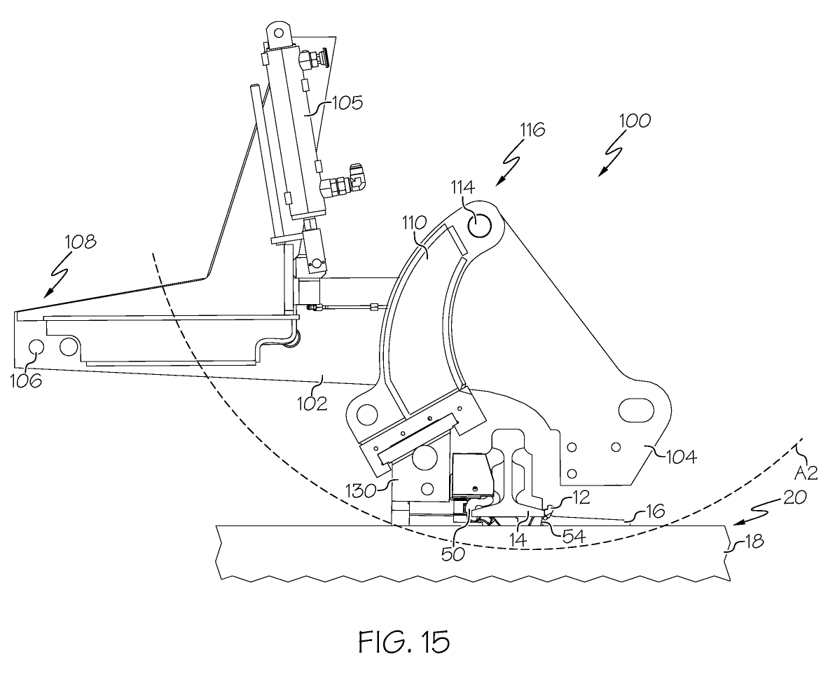

Referring primarily to FIGS. 14 and 15, from the third position (FIG. 13), in which the anchor is retrieved and clamped into the retracted jaw, the workhead is movable downward D to a lowered position. Movement of the workhead to the lowered positioned moves the pivot arm and the anchor supported thereon downward D toward the rail to a fourth position (FIG. 14) of the pivot arm in which the anchor is ready to be applied. The workhead is pivotable at a workhead pivot joint 108 about a workhead pivot axis 106, e.g. CW rotation R3, to pivot the workhead and pivot arm mounted thereto downward. Referring to FIGS. 11-15, a powered drive cylinder 105 is positioned to drive the workhead between the raised and lowered position. The frame of the machine further supports a separate powered drive cylinder positioned to drive rotation of the pivot arm about the workhead.

From the fourth position (FIG. 14), the pivot arm can pivot along a second arc A2 in a first direction, e.g. CCW rotation R4 at arm pivot joint, to a fifth position (FIG. 15) in which the anchor is clamped to the rail. The second arc A2 is coplanar with the first arc A1.

The anchor may be compressed between components of the workhead. In one embodiment, the anchor may be compressed between an anvil 104 of the workhead and the jaw, which are positioned on opposite sides of the rail (see, e.g. FIG. 15). While pressure may be applied from one or more components of the anchor applicator (e.g. the pivot arm, the jaw, the anvil, and the like), compression of the anchor may occur transversely across the rail from both the field side FS and the gage side GS. The anchor may be “sandwiched” between the anchor applicator components such that the opposing compressive forces are transverse to the rail and parallel with the tie.

The foregoing description of first, second, third, fourth, and fifth positions is exemplary. Additional positions are contemplated prior to the first position, after the fifth position, and intermediate the various positioned disclosed herein. Moreover, alternative linkages and pivot joints may be incorporated into the anchor applicator to transition the pivot arm and workhead into and between the various configurations disclosed herein. Suitable drivers for effecting movement of the workhead and pivot arm may include linkages, racks, gears, and screws driven by electric motors and/or fluidic actuators (pneumatic and hydraulic), with may be selected with reference to end use requirements and parameters.

The jaw is depicted in FIGS. 8-10. The jaw may be pivotable by the pivot arm toward the anchor delivery chute to retrieve the anchor in the loaded position at the delivery location from the anchor delivery chute. The anchor is transferred from the anchor delivery chute to the jaw and held or gripped to the jaw by a clamp 132, which subsequently releases the anchor to apply the anchor to the track.

The jaw may include a leading face 134 that is pivotable toward the anchor delivery chute to retrieve the anchor, an anchor support surface 136 extending from the leading face into the jaw, and a jaw sidewall 137 forming a side boundary for an opening 138 defined into the jaw along the anchor support surface. The opening is dimensioned to slidably receive at least a portion of the anchor in a head-first orientation from the anchor delivery chute. For example, the anchor is selectively released from the anchor delivery chute and dimensioned to slide into the opening under gravitational forces. In other instances, the jaw is structured and positioned the swing about the pivot arm into engagement with the anchor to retrieve it from the anchor delivery chute. The clamp is movable into a clamped position relative to the jaw to clamp the head of the anchor to the jaw. In the clamped configuration, the anchor support surface supports at least a portion of the underside of the belly and the tail extends beyond the leading face beyond the jaw.

The anchor support surface of the jaw defines a contour structured to match a contoured portion of the underside of the belly of the anchor. A cutout 138 in the anchor support surface is positioned adjacent to the contour to space the neck of the anchor apart from the adjacent portion of the anchor support surface. The cutout provides a clearance of an anchor key, further described herein.

The jaw may include a crown 140 dimensioned to support the head of the anchor. For example, in the second position of the pivot arm (FIG. 12), the head of the anchor engages the crown and the anchor clamped into the jaw is clamped against the crown. The opening in the jaw extends to a rear boundary surface 142 of the crown. The rear boundary surface comprises a circular recess 144 dimensioned to receive a portion of the head of the anchor.

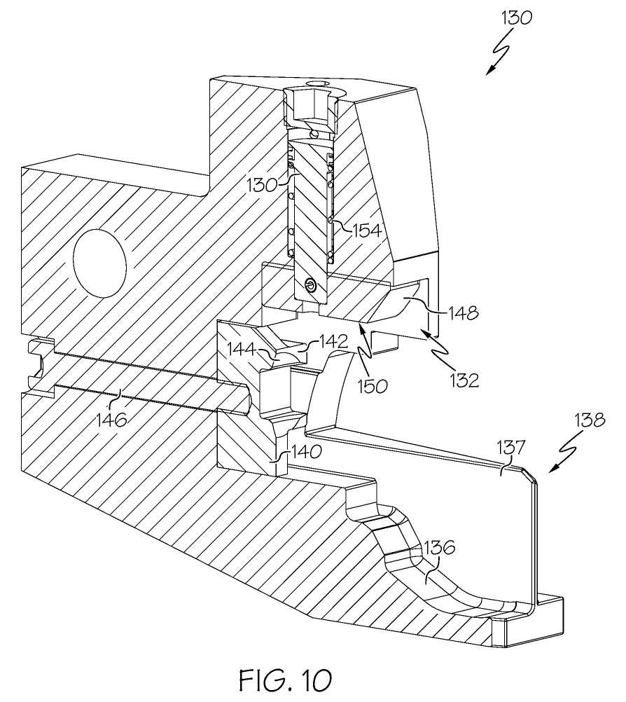

In some cases, the crown may be replaceable as it wears down over time and repeated usage. For example, a replaceable crown is securable by an accessible fastener 146 (FIG. 10). In some cases, the crown may be a different material than the jaw. The material may be selected to effectively hold and secure the anchor clamped into the jaw. For example, the crown may be a more resilient material than that of the body of the jaw. Exemplary crown materials include plastic and metal. Suitable plastics include thermoplastics and thermoset materials. Suitable metals can be zinc, tin, brass, steel, etc. The material can be selected with reference to end use parameters and requirements. The crown may be held to the jaw via clamp, screw, bolt, tab and slot, and adhesives. In one embodiment, the crown may be configured to slip over the jaw with fasteners to secure it in place. In one embodiment, the crown may be welded, and therefore not considered to be replaceable. Different surface textures and materials may be selected with reference to end use requirements. For example, for use in snowy and icy weather, a different crown may be used as compared to very hot dry weather.

The clamp for the jaw may include a pad or grip 148. The grip may have an anchor-facing clamping surface 150. The anchor-facing clamping surface may be non-serrated; however, in other aspects the anchor-facing clamping surface may be knurled, patterned, or serrated. The texture of the anchor-facing clamping surface may be selected based at least in part on the anchor and/or application thereof. In some cases, the pad may be replaceable, such that it may be replaced as it wears down over time and repeated usage. In some cases, the pad is a different material than the jaw and/or the crown. The material of the pad is selected to effectively hold and secure the anchor clamped into the jaw. For example, the pad may be more resilient than the body of the jaw. Exemplary pad materials may be selected as are the crown materials.

The clamp may be actuated by a fluidic actuator 156 (FIG. 8, depicted schematically). The actuator may move the clamp, including the grip thereof, to (and from) a clamped configuration relative to the anchor to hold and clamp the anchor within the opening of the jaw. That is, it may be held between the grip and the anchor support surface and against the crown. The fluidic actuator 156 may be actuatable to drive a piston 152, which pushes the grip downward toward the anchor support surface. A spring 154 may be positioned to bias the clamp toward an unclamped position unless the fluidic actuator is actuated to overcome the spring bias. A suitable spring may be a helical coil spring. The clamp may be actuated to hold the anchor upon release of the anchor from the anchor delivery chute to transfer the anchor between the anchor delivery chute and the jaw.

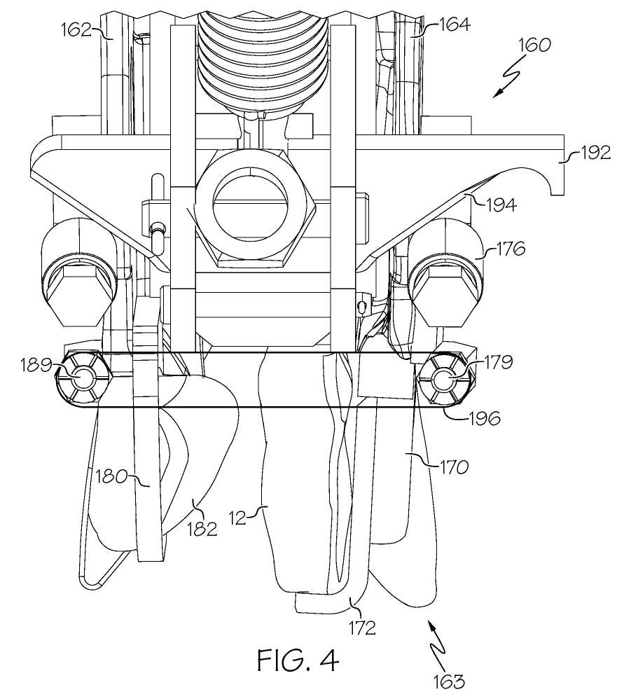

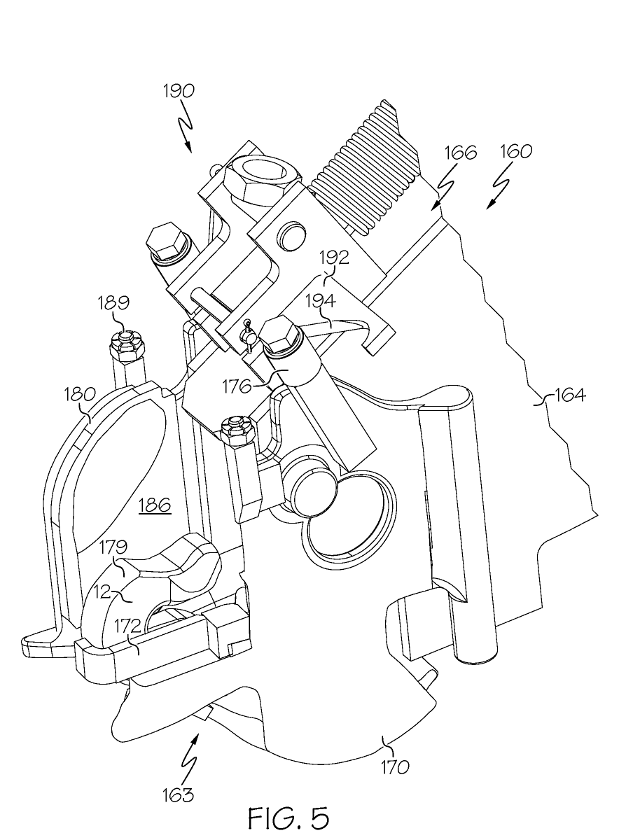

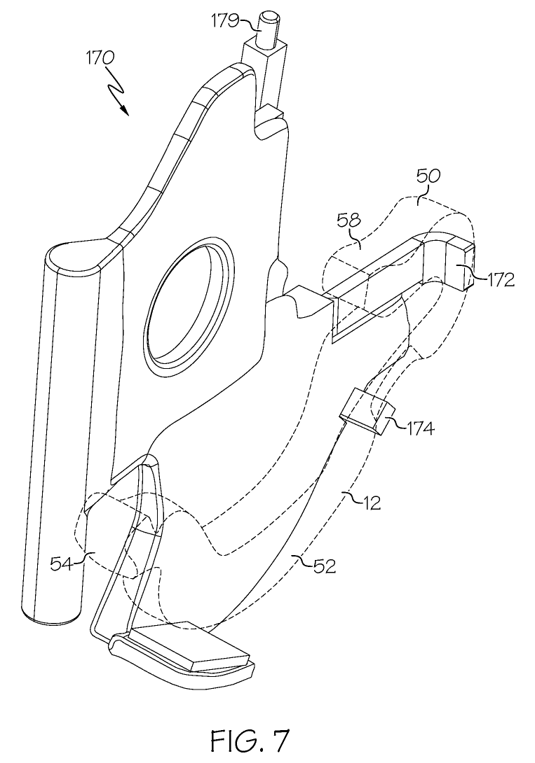

Referring now to FIGS. 3-7, the anchor delivery chute is depicted. The anchor delivery chute may include a first sidewall 162, a second sidewall 164 parallel to and facing the first sidewall, and a track 166 positioned between the first sidewall and the second sidewall. The anchor is positionable along the track (manually and/or mechanically/robotically) and is dimensioned to slide into the loaded position (FIGS. 4 and 5) in the anchor delivery chute under gravitational forces. For example, the anchor delivery chute may include a manual feed end 161 opposite a delivery location 163 of the anchor. In such instances, the anchor is manually positionable in the anchor delivery chute to slide along the track in a head-first orientation from the manual feed end.

The anchor delivery chute further may include at least one catch door 170 coupled to the first or second sidewall. The catch door is pivotably coupled to the second sidewall in the depicted embodiment. In one embodiment, the first sidewall may include a catch door coupled thereto. The catch door is structured to hold the anchor in the loaded position at the delivery location at or near the end of the track.

The catch door may include an anchor head hook 172 extending away from the catch door around at least a portion of the head in the loaded position toward the opposing sidewall (e.g. the first sidewall in FIGS. 2-5). The hook protrudes towards the jaw and bends to form a stop for the head 52 of the head-first anchor moving into the loaded position. The catch door further may include an anchor key 174 positioned to extend under the neck of the anchor in the loaded position to secure and support the anchor in the loaded position. The anchor key is dimensioned to support the anchor while providing sufficient clearance for the jaw to reach into the anchor delivery chute to transfer the anchor into the jaw.

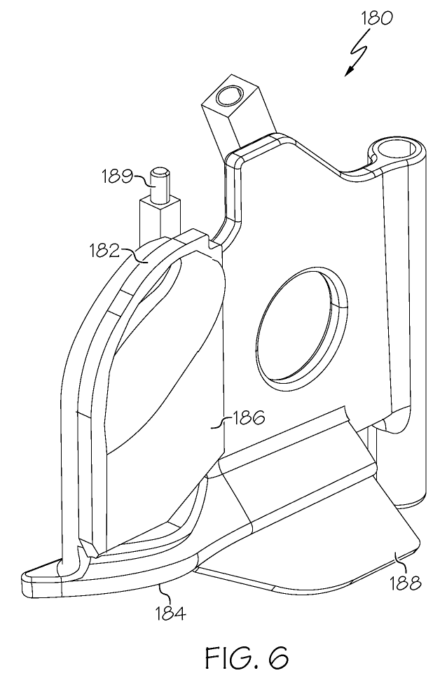

The anchor delivery chute further may include a guide door opposite the catch door and facing the anchor positioned in the loaded position. The guide door comprises an upper edge 182, a lower edge 184, and a three-dimensional contour face 186 intermediate the upper edge and the lower edge and opposing the catch door. Referring primarily to FIG. 6, the guide door further may include a ramped extension 188 protruding downwardly from the lower edge. The three-dimensional contour face and the ramped extension cooperate to guide the anchor into the loaded position. The guide door is pivotably mounted to the first sidewall; however, alternative embodiments are envisioned in which the guide door is a stationary door.

The anchor delivery chute further may include an actuator 190 that can pivot the catch door relative to the second sidewall to release the anchor from the loaded position. The actuator may have a hydraulic cylinder with a piston for pushing a cam plate 192. The cam plate may be actuatable to open the catch door. More specifically, actuation of the cam plate pushes a cam surface 194 thereof to engage a cam rod 176 mounted to the catch door. The cam surface faces the cam rod and slopes in a direction transverse to the cam rod. The actuation of the actuator 190 cammingly engages the cam rod along the cam surface to pivot the catch door relative to the first sidewall and release the anchor from the loaded position therein.

The anchor delivery chute further may include a spring 196 (FIG. 4) positioned to bias the catch door and the guide door toward a closed position in which the catch door is structured to hold the anchor in the loaded position. The spring is mounted to spring mounts 179, 189 on the catch door and the guide door, respectively. For example, the spring is an elastomeric loop extending between the spring mounts to bias the doors closed. Alternative spring geometries, such as a tension spring, helical spring, leaf spring, and the like may be selected with reference to end use requirements and parameters.

This written description uses examples to disclose the invention and to enable a person of ordinary skill in the relevant art to make and practice the invention, including making and using any devices or systems and performing any incorporated methods. The patentable scope of the invention is defined by the claims. Such other examples are within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

What is claimed is:

1. A machine for applying rail anchors, the machine comprising:
a frame;
a workhead pivotably mounted to the frame;
a pivot arm pivotably mounted to the workhead;
an anchor delivery chute mounted to the frame and dimensioned to hold an anchor;
an actuator actuatable to release the anchor from the anchor delivery chute;
a jaw pivotable by the pivot arm toward the anchor delivery chute; and
a clamp to releasably clamp the anchor to the jaw to retrieve the anchor from the anchor delivery chute.

2. The machine of claim 1, wherein the anchor delivery chute further comprises a door at an end of the anchor delivery chute, and the actuator is positioned to pivot the door to release the anchor positioned at the end of the anchor delivery chute.

3. A machine, comprising:
an anchor delivery chute, comprising:
a first sidewall;
a second sidewall;
a track positioned between the first sidewall and the second sidewall, which is configured to facilitate an anchor to slide into a loaded position in the anchor delivery chute under gravitational forces; and
a release door pivotably coupled to the first sidewall; and
an actuator to pivot the release door relative to the first sidewall to release the anchor from the loaded position.

4. The machine of claim 3, wherein the release door further comprises a cam rod, and the actuator comprises a cam surface facing the cam rod, wherein the cam surface slopes in a direction transverse to the cam rod, and an actuation of the actuator cammingly engages the cam rod along the cam surface to pivot the release door relative to the first sidewall.

5. The machine of claim 4, further comprising a spring positioned to bias the release door toward a closed position, in which the release door is structured to hold the anchor in the loaded position.

6. The machine of claim 5, wherein the release door is one of a plurality of doors, and the anchor delivery chute further comprises a second door pivotably coupled to the second sidewall.

7. The machine of claim 6, wherein the release door comprises a first spring mount, and the second door comprises a second spring mount, and the spring is a tension spring extending between the first spring mount and the second spring mount.

8. The machine of claim 3, wherein the anchor delivery chute comprises a manual feed end opposite the release door, and the anchor delivery chute is configured to slide an anchor along the track in a head-first orientation from the manual feed end toward the release door.

9. The machine of claim 3, further comprising the anchor, and the anchor has a head, a neck adjacent to the head, a tail, and a belly extending between the neck and the tail, and the release door further comprises an anchor head hook extending away from the door around at least a portion of the head toward the second sidewall.

10. The machine of claim 9, wherein the release door further comprises an anchor key positioned to extend under the neck of the anchor while it is in a loaded position.

11. The machine of claim 3, wherein the release door is one of a plurality of doors, and the anchor delivery chute further comprises a second door mounted to the second sidewall, and the second door comprises:
an upper edge and a lower edge;
a three-dimensional contour face intermediate the upper edge and the lower edge and opposing the release door; and
a ramped extension protruding downwardly from a bottom edge, and the three-dimensional contour face and the ramped extension cooperate to guide an anchor into a loaded position.

12. A machine for applying an anchor, the anchor comprising a head, a tail, and a belly extending between the head and the tail, the machine comprising:
a frame movable along a longitudinal rail axis;
a workhead pivotably mounted to the frame, the workhead pivotable in a plane transverse to the longitudinal rail axis;
a pivot arm pivotably mounted to the workhead;
an anchor delivery chute dimensioned to hold at least one anchor;
a jaw pivotable by the pivot arm toward the anchor delivery chute; and
a clamp to releasably clamp the head of the anchor to the jaw to retrieve the anchor from the anchor delivery chute.

13. The machine of claim 12, wherein the pivot arm is pivotable along a first arc in a first direction to retrieve the anchor, and the pivot arm is pivotable along a second arc in the first direction to apply the anchor, and the first arc and the second arc are coplanar.

14. The machine of claim 12, wherein the jaw has:
a leading face pivotable toward the anchor delivery chute to retrieve the anchor; and
an anchor support surface extending from the leading face into the jaw, with an opening being defined by the jaw along the anchor support surface, and the opening is dimensioned to slidably receive at least a portion of the anchor in a head-first orientation from the anchor delivery chute, and the clamp is selectively movable to a clamped position relative to the jaw to clamp the head of the anchor to the jaw, and, in the clamped position, the anchor support surface supports at least a portion of the belly and the tail extends beyond the leading face beyond the jaw.

15. The machine of claim 14, further comprising the anchor, the anchor defining:
a neck between the head and the belly, and the neck comprises a smaller cross-section than the head and the belly,
an ear protruding from the head and extending toward the tail, and the ear terminates at a crest, and the ear comprises a smaller cross-section than the head; and
a notch along the tail facing the ear.

16. The machine of claim 15, wherein the anchor support surface further defines:
a contour structured to match a contoured portion of belly; and
a cutout adjacent to the contour such that the neck is spaced apart from the anchor support surface.

17. The machine of claim 16, wherein the anchor delivery chute is fixed to the frame and the workhead is movable relative to the frame between a raised position and a lower position.

18. The machine of claim 12, wherein the jaw further comprises a replaceable crown dimensioned to support the head of the anchor.

19. The machine of claim 18, wherein an opening extends into the jaw to a rear boundary surface of the replaceable crown, wherein the rear boundary surface comprises a circular recess dimensioned to receive a portion of the head of the anchor.

20. The machine of claim 19, wherein the clamp comprises a replaceable grip comprising an anchor-facing clamping surface, and the opening is further defined between the anchor-facing clamping surface, a sidewall of the jaw, and the rear boundary surface of the replaceable crown.
